(19) United States
(12) Patent Application Publication
(10) Pub. No.: US 2024/0336868 A1
(43) Pub. Date: Oct. 10, 2024

(54) COMPOSITIONS COMPRISING ADAMANTYL ESTER-CONTAINING COMPOUNDS

(71) Applicant: The Procter & Gamble Company, Cincinnati, OH (US)

(72) Inventors: Philip John PORTER, Mason, OH (US); Bernardo M. AGUILERA-MERCADO, Kenwood, OH (US); Mu WANG, Cincinnati, OH (US); Ryan Johnie SMITH, Cincinnati, OH (US); Gregory Scot MIRACLE, Liberty Township, OH (US); William Peter MCDERMOTT, III, Cincinnati, OH (US); Michael Patrick HAYES, Clarksville, OH (US); Karen Hussong STRADER, Springboro, OH (US); Kelly Marie VAN HAREN, Chicago, IL (US); Fabrizio MELI, Montgomery, OH (US)

(21) Appl. No.: 18/627,520

(22) Filed: Apr. 5, 2024

Related U.S. Application Data
(60) Provisional application No. 63/494,884, filed on Apr. 7, 2023.

(51) Int. Cl. C11B 9/00

(52) U.S. Cl. CPC C11B 9/0053

(57) ABSTRACT

Compositions, such as consumer products and/or fragrance compositions, that include an adamantyl ester-containing compound.

### FIELD OF THE INVENTION

The present disclosure relates to compositions, such as consumer products and/or fragrance compositions, that include adamantyl ester-containing perfumes. The present disclosure further relates to processes of making and using such compositions.

### BACKGROUND OF THE INVENTION

Consumer products that incorporate a pleasing scent, such as cleaning products, soaps, detergents, fabric fresheners, antiperspirants, air fresheners, and fine fragrances, are always in high demand. One popular fragrance material traditionally used in, and associated with, consumer products is octahydrotetramethyl acetophenone, a.k.a., 1-(1,2,3,4,5,6,7,8-Octahydro-2,3,8,8-tetramethyl-2-naphthalenyl) ethanone, a.k.a., OTNE. In situations where OTNE is not available, there exists a need for substitute fragrance materials that have a similar scent profile. Accordingly, there is a continuing need for new fragrance materials that can be utilized in consumer products, compositions, and related processes.

### SUMMARY OF THE INVENTION

The present disclosure relates to compositions, such as consumer products and/or fragrance compositions, that include an adamantyl ester-containing compound, such as 2-methyl-2-adamantyl acetate, 2-adamantyl acetate, or 2-adamantyl propanoate.

For example, the present disclosure relates to a consumer product that includes: a first fragrance material that is an adamantyl ester containing compound, where the first fragrance material is present in an amount of at least 0.0005%, by weight of the consumer product composition, and a treatment adjunct.

The present disclosure also relates to a process of making a consumer product, the process including the steps of combining a first fragrance material with a treatment adjunct or a substrate, where the first fragrance material is an adamantyl ester-containing compound.

The present disclosure also relates to a process of treating a surface or an environment, the process including the step of providing an adamantyl ester-containing compound, to a surface or environment.

The present disclosure also relates to a use of an adamantyl ester-containing compound in a consumer product, a surface, or an environment.

### DETAILED DESCRIPTION OF THE INVENTION

The present disclosure relates to compositions, consumer products, and processes that include adamantyl ester-containing compounds as a substitute for OTNE. The adamantyl ester-containing, G-C(O)—O-Q structured compounds detailed herein differ from compounds previously known in the art and suggested as perfumes in at least one of two ways. Either the previously known compounds have the adamantyl group as part of the G radical, or alternatively, the adamantyl group is part of the Q radical, but more than one carbon of the adamantyl group is substituted. We are not aware of any known perfume compounds where single positionally-substituted adamantyl groups have been placed in the Q radical. Accordingly, it is surprising to find that these long-ignored materials are very useful fragrance materials, for example, evidencing surprisingly high headspace properties. In addition to a similar scent profile to OTNE, i.e., having notes of cedarwood and amber, the adamantyl ester-containing compounds also have certain advantageous characteristics that can make them more attractive to consumer product manufacturers. For example, because the adamantyl ester-containing compounds described herein have a relatively higher headspace compared to OTNE, adamantyl ester-containing compounds may be even more preferable by saving on raw material costs, carbon footprint and/or formulation space. Moreover, because the adamantyl esters contain an ester bond, adamantyl ester-containing compounds would also be expected to have improved biodegradability. In addition, the adamantyl ester-containing compounds detailed herein may also have improved resistance to oxidation and better bloom (i.e., volatility).

The fragrance materials, compositions, consumer products, and related processes are discussed in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein, “consumer products” can include baby care, beauty care, fabric & home care, family care, feminine care, health care, food (including snack), beverage, and/or fine fragrance products or devices generally intended to be used or consumed in the form in which it is sold. Such products include but are not limited to diapers, bibs, wipes; products for and/or methods relating to treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use including fine fragrances; and shaving products, products for and/or methods relating to treating fabrics, hard surfaces and any other surfaces in the area of fabric and home care, including: air care including air fresheners and scent delivery systems, car care, dishwashing, fabric conditioning (including softening and/or freshening), laundry detergency, laundry and rinse additive and/or care, hard surface cleaning and/or treatment including floor and toilet bowl cleaners, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening; over-the-counter health care including cough and cold remedies, pain relievers, RX pharmaceuticals, pet health and nutrition; food products, including processed food products intended primarily for consumption between customary meals or as a meal accompaniment (non-limiting examples include potato chips, tortilla chips, popcorn, pretzels, corn chips, cereal bars, vegetable chips or crisps, snack mixes, party mixes, multigrain chips, snack crackers, cheese snacks, pork rinds, corn snacks, pellet snacks, extruded snacks and bagel chips); beverages, including carbonated beverages, tea, flavored water, and coffee; and water purification.

As used herein the phrase “fabric care product” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

Unless otherwise noted, all component or composition levels are in reference to the active portion of that component or composition, and are exclusive of impurities, for example, residual solvents or by-products (including minor decomposition products that may form upon storage), which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Adamantyl Ester-Containing Compounds:

The compositions, products, and processes described herein include an adamantyl ester-containing compound. As described in more detail below, it is believed that such materials can provide a pleasing scent to compositions and products (i.e., a similar scent profile to OTNE) while also having certain advantageous characteristics, such as a more noticeable bloom of the fragrance, that facilitate savings in raw material costs, carbon footprint and/or formulation space.

As described herein, the particular detailed adamantyl ester-containing compounds are referred to as a (first) fragrance material.

The basic structure of the particular adamantyl ester-containing compounds is G-C(O)—O-Q. The G and Q are carbon-containing radicals that are connected only through an ester bond. Q comprises a single adamantyl moiety, and only one carbon atom of the adamantyl moiety is substituted with something other than hydrogen. Accordingly, the compounds are selected from either:

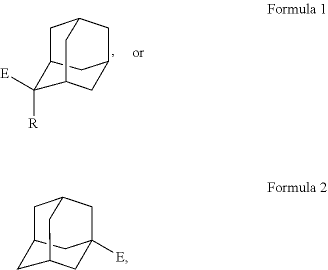

or
mixtures thereof.
For either Formula 1 or Formula 2:
1. R is a hydrogen or a hydrocarbyl;
2. E contains only a single —CO₂— moiety;
3. the molecular formula is C₁₁₊ₙH₁₆₊₂ₙ₋ₘO₂,
   wherein n is an integer from 1 to 7, preferably from 1 to 5, more preferably from 1 to 3, even more preferably from 1 to 2; and
   m is 0 or 2; and
   wherein when m is 0, the molecule contains no carbon-carbon double bonds; and
   wherein when m is 2, the molecule contains a single carbon-carbon double bond, and preferably the carbon-carbon double bond is directly bonded to the carbonyl carbon atom.
      Non-limiting examples of the adamantyl ester-containing compounds detailed herein include:

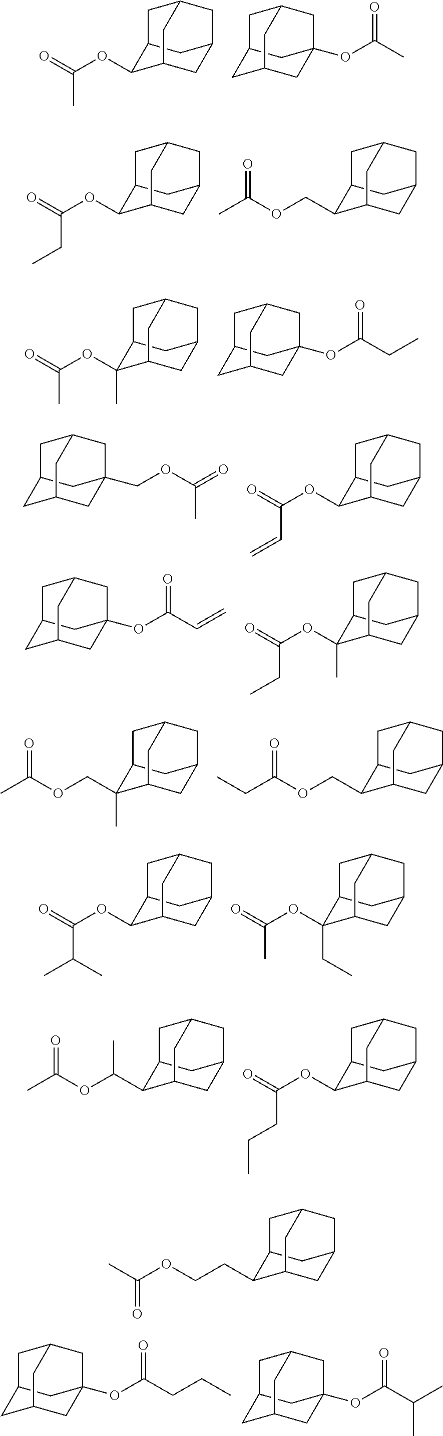

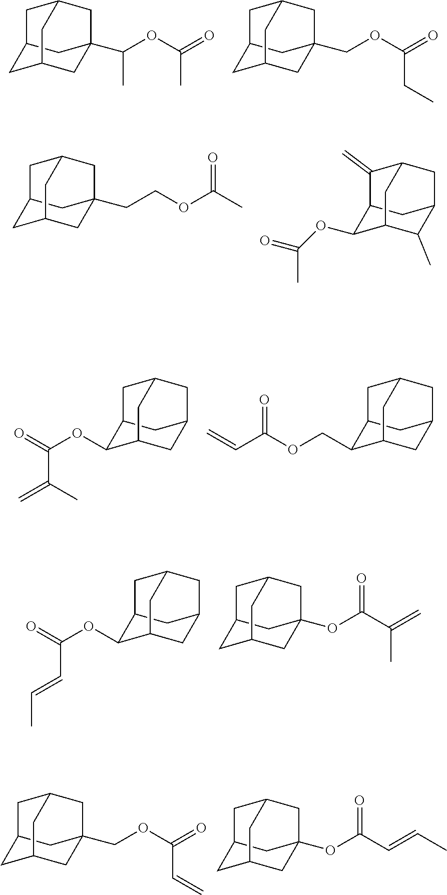

As described further in the Examples section below, certain interesting adamantyl ester-containing compounds such as, but not limited to, 2-methyl-2-adamantyl acetate, 2-adamantyl acetate, or 2-adamantyl propanoate are characterized by an OTNE-like scent profile, as well as certain other desirable characteristics, including high headspace, that may make them desirable replacements for OTNE in consumer products.

### Consumer Products

The present disclosure relates to consumer products that comprise an adamantyl ester-containing compound. Typically, the consumer products will also comprise a treatment adjunct. Additionally, or alternatively, the consumer product may comprise an adamantyl ester-containing compound that is provided to a substrate.

The consumer product may take any suitable form. Preferably, the consumer product is a baby care product, a beauty care product, a fabric care product, a home care product, a family care product, a feminine care product, a health care product, a food product, a beverage product, a fine fragrance product, or a combination thereof. The consumer products of the present disclosure may be compositions, devices, or combinations thereof that are useful in baby care, beauty care, fabric care, home care, family care, feminine care, health care, food, beverage, and/or fine fragrance applications. For consumer health reasons, it may be preferred that the consumer product is not a tobacco-related product, such as cigarettes, e-cigarettes, or products (such as aerosols) intended to give a tobacco-like aroma.

The consumer product may preferably be a fabric care product and/or a home care product, wherein the home care product is selected from the group consisting of a hard surface cleaner, a dish care product, an air care product, or a combination thereof. The consumer product may be a cleaning and/or treatment product.

The consumer product may take any suitable form or combination of forms. For example, the consumer product may comprise a form selected from a liquid composition, a granular composition, a hydrocolloid, a single-compartment pouch, a multi-compartment pouch, a dissolvable sheet, a pastille or bead, a fibrous article, a tablet, a stick, a bar, a flake, a spray, a foam/mousse, a non-woven sheet, a dispensing device, a cream, an absorbent article, a paste, an adhesive, an adhesive patch, or a mixture thereof. The consumer product may be a composition, such as a liquid composition, that is housed in a container, dispensing device, or other suitable article.

The consumer product may comprise a first fragrance material that is an adamantyl ester-containing compound, where the first fragrance material is present in an amount of at least 0.0005%, by weight of the consumer product, and a treatment adjunct.

The consumer product may comprise the first fragrance material (an adamantyl ester-containing compound) in an amount of at least 0.0005%, preferably at least 0.001%, more preferably at least 0.01%, preferably in an amount of at least 0.1%, preferably at least 0.5%, more preferably at least 1%, by weight of the consumer product. It is preferred to have a certain minimum amount of the first fragrance material present in order to deliver the desired olfactory performance.

The consumer product may comprise the first fragrance material (an adamantyl ester-containing compound) in an amount of up to about 99%, preferably up to an amount of about 50%, preferably up to about 25%, more preferably up to about 10%, even more preferably up to about 5%, even more preferably up to about 1%, by weight of the consumer product. It may be preferred to have a certain maximum amount or limit of the first fragrance material present in order to include other adjuncts or fragrance materials.

The consumer product may comprise the first fragrance material (an adamantyl ester-containing compound) in an amount of from about 0.01% to about 99%, preferably from about 0.1% to about 50%, more preferably from about 0.5% to about 10%, more preferably from about 1% to about 5%, by weight of the consumer product.

The consumer product may comprise the first fragrance material (an adamantyl ester-containing compound) and a second fragrance material selected from the group consisting of any fragrance material that is suitable for the intended product or end use, wherein the total fragrance material is made up of least 10%, more preferably at least 20%, more preferably at least 30%, more preferably at least 40%, more preferably at least 50%, more preferably at least 60%, more preferably at least 70%, more preferably at least 80%, more preferably at least 90%, more preferably at least 95% biodegradable materials. The term “biodegradable” is defined herein as chemical dissolution, disintegration, or digestion of biodegradable perfume by bacteria or other biological means at a rate above 50% according to the OECD301 C test method, which defines readily biodegradability of materials. In this test the biodegradable perfumes are suspended in a phosphate buffered media containing an activated sludge inoculum and the consumption of oxygen and or the formation of carbon dioxide is measured via an electrolytic respirometer. The test substance is the sole carbon and energy source and under aerobic conditions microorganisms metabolize organic substances producing CO2 as the ultimate product.

For example, the consumer product may comprise: a first fragrance material that is an adamantyl ester-containing compound; an optional second fragrance material selected from the group of OTNE, 4-methyl-8-methylene-tricyclo[3.3.1.1^{3,7}]decan-2-ol acetate, and mixtures thereof; and a treatment adjunct; wherein the weight ratio of the first fragrance material to the second fragrance material, if present, is from 100:0 to 1:99.

The weight ratio of the first fragrance material (an adamantyl ester-containing compound) to the second fragrance material selected from the group of OTNE, 4-methyl-8-methylene-tricyclo[3.3.1.1^{3,7}]decan-2-ol acetate, and mixtures thereof may be from 100:0 to 1:99, preferably from 100:0 to 25:75, preferably from 100:0 to 50:50, more preferably from 100:0 to 51:49, more preferably from 100:0 to 75:25, more preferably from 100:0 to 90:10, more preferably from 100:0 to 95:5, more preferably from 100:0 to 99:1.

It may be preferred to formulate only the presently disclosed materials and to leave out other fragrance materials. For example, the consumer product may be substantially free of a second fragrance material such as OTNE and 4-methyl-8-methylene-tricyclo[3.3.1.1^{3,7}]decan-2-ol acetate. In particular, a consumer product may comprise adamantyl ester-containing compound and be substantially free of OTNE.

The first fragrance material may be present as a free oil in the consumer product, or it may be part of a perfume delivery system. For example, the adamantyl ester-containing compound may be encapsulated, or otherwise associated with (e.g., embedded in), a delivery particle. For example, the adamantyl ester-containing compound may be in the core of a core-shell delivery particle. The adamantyl ester-containing compound may be covalently or ionically bonded, preferably covalently bonded, to a carrier material, thereby forming a pro-fragrance material that releases the adamantyl ester-containing compound when the bond is broken, such as through exposure to water or light. Thus, the first fragrance material, e.g., adamantyl ester-containing compound, may be part of a perfume delivery system, where the perfume delivery system is a delivery particle, a pro-fragrance material, or a combination thereof.

As described above, the consumer product comprises a treatment adjunct. The treatment adjunct material may provide a benefit in the intended end-use of a composition, or it may be a processing and/or stability aid. The precise nature of the treatment adjunct(s), and levels of incorporation thereof, will depend on the physical form of the composition and the nature of the operation for which it is to be used. One of ordinary skill will be able to select appropriate materials and levels for a given product or application.

Suitable treatment adjuncts may include antioxidants, surfactants, conditioning actives, deposition aids, rheology modifiers or structurants, bleach systems, stabilizers, builders, chelating agents, dye transfer inhibiting agents, dispersants, enzymes, enzyme stabilizers, catalytic metal complexes, polymeric dispersing agents, clay and soil removal/anti-redeposition agents, brighteners, suds suppressors, silicones, hueing agents, aesthetic dyes, neat perfume, additional perfume delivery systems, structure elasticizing agents, carriers, hydrotropes, processing aids, anti-agglomeration agents, coatings, formaldehyde scavengers, pigments, or mixtures thereof.

The treatment adjunct may comprise a carrier. Such carriers may be hydrophilic (e.g., water) or hydrophobic (e.g, an oil) in nature. The presently described adamantyl ester-containing compounds are relatively hydrophobic in nature and may be conveniently coupled with a hydrophobic carrier. Particularly useful carriers in consumer products include, but are not limited to, isopropyl myristate (IPM), Neobee® caprylic/capric triglyceride, dipropylene glycol, propylene glycol monomethyl ether (DPM), tripropyleneglycol monomethyl ester (TPM), triethyl citrate (TEC), or mixtures thereof. Thus, the consumer product may comprise a carrier, where the carrier is preferably IPM, DPM, or mixtures thereof. Preferably, the carrier comprises isopropyl myristate.

Isopropyl myristate, as well as other hydrophobic carriers, may be particularly useful when the adamantyl ester-containing compound is encapsulated in certain core-shell delivery particles, such as those having acrylate-based or chitosan-based shells. The cores of the delivery particles may comprise both the isopropyl myristate and the adamantyl ester-containing compound.

### Fragrance Composition

The present disclosure also relates to fragrance compositions. Such compositions typically comprise mixtures of fragrance ingredients. The fragrance compositions of the present disclosure may take the form of premixes or intermediate compositions that are combined with other materials to make final products, such as consumer products.

For example, the fragrance composition may take the form of a fragrance composition that is a mixture of fragrance materials, such as a perfume accord that may be formulated into a consumer product.

The fragrance composition may comprise a first fragrance material and a second fragrance material that is different than the first fragrance material, where the first fragrance material is an adamantyl ester-containing compound, preferably 2-adamantyl propanoate, more preferably 2-adamantyl acetate, even more preferably 2-methyl-2-adamantyl acetate, and where the first fragrance material is present in an amount of at least 1%, by weight of the fragrance composition.

The first fragrance material may be present in an amount of at least 0.005%, preferably at least 0.05%, or even 0.1%. The first fragrance material may be present in an amount of from about 0.005% to about 10%, preferably from about 0.05% to about 3%, more preferably from about 0.1% to about 1.5%. The first fragrance material may be present in an amount of at least 1%, preferably at least 2%, more preferably at least 5%, or even at least 10%, or even at least 20%, by weight of the fragrance composition. The first fragrance material may be present in an amount of from 1% to about 99%, preferably from 1% to about 50%, more preferably from about 1% to about 25%, more preferably from about 1% to about 10%, even more preferably from about 1% to about 5%, by weight of the fragrance composition.

The second fragrance material may be selected from the group consisting of any fragrance material that is suitable for the intended product or end use. The term “perfume raw material” (or “PRM”) as used herein refers to compounds having a molecular weight of at least about 100 g/mol and which are useful in imparting an odor, fragrance, essence, or scent, either alone or with other perfume raw materials. Typical PRMs comprise inter alia aromatic and/or aliphatic alcohols, ketones, aldehydes, esters, ethers, carboxylic acids, nitriles, nitrites and alkenes, such as terpene, and alkynes. A listing of common PRMs can be found in various reference sources, for example, “Perfume and Flavor Chemicals”, Vols. I and II; Steffen Arctander Allured Pub. Co. (1994) and “Perfumes: Art, Science and Technology”, Miller, P. M. and Lamparsky, D., Blackie Academic and Professional (1994).

As non-limiting, illustrative examples, suitable second fragrance materials are provided below in Table A. The second fragrance material may be selected from the group provided in Table A, or combinations thereof.

TABLE A

| CAS# | Second Fragrance Material |
|---|---|
| 32210-23-4 | 4-tert-Butylcyclohexyl acetate |
| 67874-81-1 | Cedryl methyl ether |
| 58567-11-6 | Boisambrene forte |
| 476332-65-7 | Amber Xtreme |
| 211299-54-6 | Ambrocenide |
| 32388-55-9 | Acetylcedrene |
| 139504-68-0 | 1-(2-tert-Butylcyclohexyloxy)-2-butanol |
| 28219-61-6 | Bacdanol |
| 118562-73-5 | 2-Cyclododecylpropan-1-ol |
| 154171-77-4 | Spiro[1,3-dioxolane-2,8′(5′H)-[2H-2, |
| | 4a]methanonaphthalene], hexahydro-1′,1′,5′,5′- |
| | tetramethyl-, (2′S,4′aS,8′aS) |

In some embodiments, the second fragrance material may be OTNE, or 4-methyl-8-methylene-tricyclo[3.3.1.1^{3,7}]decan-2-ol acetate. That being said, it may be particularly preferred to control the weight ratio of the adamantyl ester-containing compound to its counterpart. For example, the weight ratio of adamantyl ester-containing compound to the second fragrance material may be from 100:0 to 1:99, preferably from 100:0 to 25:75, preferably from 100:0 to 50:50, more preferably from 100:0 to 51:49, more preferably from 100:0 to 75:25, more preferably from 100:0 to 90:10, more preferably from 100:0 to 95:5, more preferably from 100:0 to 99:1.

In order to provide a full and desirable olfactory experience, the fragrance composition may comprise three or more fragrance materials. The fragrance composition may further comprise a third fragrance material. The fragrance composition may comprise from two to about fifty fragrance materials, preferably from two to about thirty fragrance materials. For simplicity and case of manufacturing, it may be desirable to limit the number of components of the fragrance composition. For example, the fragrance composition may comprise from two to about twenty, or to about fifteen, or to about ten, fragrance materials.

The fragrance composition may further comprise a carrier, preferably a carrier comprising isopropyl myristate (IPM), Neobee® caprylic/capric triglyceride, dipropylene glycol, propylene glycol monomethyl ether (DPM), tripropyleneglycol monomethyl ester (TPM), triethyl citrate (TEC), or a mixture thereof, more preferably a carrier comprising isopropyl myristate.

Other useful carriers may be solvents or emulsifiers, such as nonionic surfactants, which may help with incorporation of the fragrance composition into a final product form. The fragrance composition may be in the form of an emulsion, preferably an oil-in-water emulsion.

The fragrance composition of the present disclosure may be incorporated into a consumer product, which are described in more detail above. Thus, the present disclosure relates to a consumer product comprising the fragrance composition as described herein. Preferably, the consumer product is a baby care product, a beauty care product, a fabric care product, a home care product, a family care product, a feminine care product, a health care product, a food product, a beverage product, a fine fragrance product, or a combination thereof.

The fragrance composition may be present in the consumer product in an amount of at least 0.1%, preferably at least 0.5%, more preferably at least 1%, by weight of the consumer product. The fragrance composition may be present in the consumer product in an amount of from about 0.1% to about 99.9%, or from about 0.1% to about 50%, or from about 0.1% to about 25%, or from about 0.1% to about 10%, or from about 0.1% to about 5%, or from about 1% to about 5%, by weight of the consumer product.

### Additional Fragrance Materials:

The fragrance compositions disclosed herein may also include additional fragrance materials. Some non-limiting examples of such additional fragrance materials are listed in Table B below. At least one of the additional fragrance materials listed in Table B may be utilized alone in a consumer product or utilized in a consumer product in combination with any other fragrance materials disclosed herein.

TABLE B

| IUPAC Name | CAS Number |
|---|---|
| 1-(3,5-dimethyladamantan-1-yl)ethan-1-one | 40430-57-7 |
| 1-Acetyladamantane | 1660-04-4 |
| 4-methyl-4-(p-tolyl)pentan-2-one | 10528-65-1 |
| 4-(4-ethylphenyl)-4-methylpentan-2-one | 13047-71-7 |
| 4-(4-(tert-butyl)phenyl)-4-methylpentan-2-one | 39866-03-0 |
| 4-(4-isopropylphenyl)-4-methylpentan-2-one | 10528-66-2 |
| 4-Methyl-4-phenyl-2-pentanone | 7403-42-1 |
| 4-oxoadamantan-1-yl propionate | 305379-04-8 |
| 4-oxoadamantan-1-yl 3,3-dimethylbutanoate | 512822-39-8 |
| 4-oxoadamantan-1-yl acrylate | 216582-09-1 |
| 4-oxo-1-adamantyl acetate | 63382-10-5 |
| (5-methylbicyclo[5.3.1]undecan-1-yl)methyl acetate | 216673-19-7 |
| (3-methyladamantan-1-yl)methyl acetate | 476415-11-9 |
| (3-ethyladamantan-1-yl)methyl acetate | 1192480-15-1 |
| (3-(2-methoxyethyl)bicyclo[3.3.1]nonan-1-yl)methyl acetate | 1588826-52-1 |
| Adamantan-1-ylmethyl acetate | 778-11-0 |
| tert-butyl 3-methylbicyclo[2.2.1]hept-5-ene-2-carboxylate | 1639268-86-2 |
| isopropyl bicyclo[2.2.1]hept-5-ene-2-carboxylate | 916824-62-9 |
| tert-pentyl bicyclo[2.2.1]hept-5-ene-2-carboxylate | 398140-58-4 |
| tert-Butyl Bicyclo[2.2.1]-5-heptene-2-carboxylate | 154970-45-3 |
| 1-(2-hydroxyphenyl)ethan-1-one | 118-93-4 |
| 1-(2,4,6-trihydroxyphenyl)ethan-1-one | 480-66-0 |
| 1-(2,6-dihydroxy-4-methylphenyl)ethan-1-one | 1634-34-0 |
| Acetylresorcinol | 102-29-4 |
| 7-methoxy-2,2-dimethyl-2,3-dihydrobenzofuran | 21763-49-5 |
| 7-ethoxy-2,2-dimethyl-2,3-dihydrobenzofuran | 53903-39-2 |
| 7-isopropoxy-2,2-dimethyl-2,3-dihydrobenzofuran | 1346169-07-0 |
| 2-((2,2-dimethyl-2,3-dihydrobenzofuran-7-yl)oxy)ethan-1-ol | 1153129-01-1 |
| 2,3-Dihydro-2,2-dimethyl-7-benzofuranol | 1563-38-8 |
| 1-(adamantan-1-yl)heptan-1-one | 32665-99-9 |
| 1-(1-(2-ethylbutyl)cyclohexyl)propan-1-one | 4966-07-0 |
| 1-(adamantan-1-yl)hexan-1-one | 32665-97-7 |
| 1-(adamantan-1-yl)butan-1-one | 24556-00-1 |
| 1-(1-adamantyl)propan-1-one | 1660-05-5 |
| 2-(3-ethylpentan-3-yl)phenol | 100532-34-1 |
| 2-(tert-pentyl)benzene-1,3-diol | 162759-98-0 |
| 2-(2-methylpentan-2-yl)phenol | 6822-69-1 |
| 2-(2,3-dimethylbutan-2-yl)phenol | 1/4/4196 |
| 2-tert-Amylphenol | 3279-27-4 |
| tetradec-12-en-1-yl acetate | 35153-21-0 |
| tridec-11-en-1-yl acetate | 33951-95-0 |
| (Z)-8-dodecen-1-ylacetate | 28079-04-1 |
| ethyl 2-(1-hydroxy-2-methylcyclohexyl)acetate | 5108-87-2 |
| ethyl 3-cyclohexyl-3-hydroxybutanoate | 28811-84-9 |
| ethyl 3-hydroxy-3,4-dimethyloctanoate | 65790-83-2 |
| ethyl (2-hydroxy-2-adamantyl)acetate | 112181-97-2 |
| 2-(benzo[d]oxazol-2-yl)ethan-1-ol | 121356-82-9 |
| 2-(benzo[d]oxazol-2-yl)acetaldehyde | 137822-12-8 |
| 2-propylbenzo[d]oxazole | 5/1/2008 |
| 2-Ethylbenzo[d]oxazole | 6797-13-3 |
| methyl 4-hydroxybicyclo[2.2.2]octane-1-carboxylate | 23062-53-5 |
| 4-methoxybicyclo[2.2.2]octane-1-carboxylic acid | 773-34-2 |
| ethyl 4-methoxy-1,4-dimethylcyclohexane-1-carboxylate | 96454-88-5 |
| methyl 4-methoxybicyclo[2.2.2]octane-1-carboxylate | 81687-90-3 |
| methyl 4-(hydroxymethyl)bicyclo[2.2.1]heptane-1- | 1350821-95-2 |
| carboxylate | |
| dimethyl bicyclo[2.2.1]heptane-1,4-dicarboxylate | 15448-76-7 |
| 4-(methoxycarbonyl)bicyclo[2.2.1]heptane-1-carboxylic acid | 15448-77-8 |
| methyl 4-(methoxymethyl)norbornane-1-carboxylate | 2725791-10-4 |
| 4-(3,5-dimethyl-1H-pyrazol-1-yl)phenol | 51011-27-9 |
| 4-(3,5-dimethyl-1H-pyrazol-1-yl)aniline | 52708-32-4 |
| 3,5-dimethyl-1-(p-tolyl)-1H-pyrazole | 20157-46-4 |
| 3,5-Dimethyl-1-phenylpyrazole | 1131-16-4 |
| 3,3′-dimethyl-1,1′-biphenyl | 612-75-9 |
| 3,4′-dimethyl-1,1′-biphenyl | 7383-90-6 |
| 3,5-dimethyl-1,1′-biphenyl | 17057-88-4 |
| 3,3′,5,5′-tetramethyl-1,1′-biphenyl | 25570-02-9 |
| 3-Methylbiphenyl | 643-93-6 |
| 2-isopropyladamantan-2-yl acetate | 251564-67-7 |
| 2,3,7-trimethylbicyclo[3.3.1]nonan-2-yl acetate | 412015-91-9 |
| Tricyclo[3.3.1.1(3,7)]decan-2-ol, 2-ethyl-, 2-acetate | 371148-20-8 |
| 2-methyltricyclo[4.3.1.1(3,8)]undecan-2-yl acetate | 128500-80-1 |
| 2-methyladamantan-2-yl butyrate | 473242-62-5 |
| Tricyclo[3.3.1.1(3,7)]decan-2-ol, 2-methyl-, 2-acetate | 58081-36-0 |
| 3-ethyl-9-methylbicyclo[3.3.1]nonan-9-yl acrylate | 2756583-36-3 |
| 3-ethyl-2,7-dimethylbicyclo[3.3.1]nonan-2-yl acrylate | 2756583-37-4 |
| 2-(sec-butyl)adamantan-2-yl acrylate | 2990634-14-3 |
| 2-ethyladamantan-2-yl acrylate | 303186-14-3 |
| 2-Methyl-2-adamantyl acrylate | 249562-06-9 |
| 2-isopropyladamantan-2-yl propionate | 2244447-13-8 |
| 2-ethyl-3-methylbicyclo[3.3.1]nonan-2-yl propionate | 1015076-15-9 |
| Tricyclo[3.3.1.1(3,7)]decan-2-ol, 2-methyl-, 2-propanoate | 634191-34-7 |
| 2,6-dibutyl-4-methylcyclohexyl acetate | 52747-27-0 |
| 3,7-dimethylbicyclo[3.3.1]nonan-2-yl acetate | 114068-65-4 |
| 2-(2-ethylhexyl)cyclohexyl acetate | 497226-68-3 |
| 2-Adamantyl acetate | 19066-22-9 |
| 2-isobutylcyclohexyl propionate | 1005073-43-7 |
| adamantan-2-yl butyrate | 959069-55-7 |
| 4-ethyl-2-methylcyclohexyl propionate | 69662-51-7 |
| Tricyclo[3.3.1.1(3,7)]decan-2-ol, 2-propanoate | 2662511-98-8 |
| 3a,4,5,6,7,7a-hexahydro-1H-4,7-methanoinden-5-yl | 67634-24-6 |
| propionate | |
| 3a,4,5,6,7,7a-hexahydro-1H-4,7-methanoinden-5-yl | 67634-20-2 |
| isobutyrate | |
| 2,3,3a,4,7,7a-hexahydro-1H-4,7-methanoinden-1-yl acetate | 585570-07-6 |
| 3a,4,5,6,7,7a-hexahydro-1H-4,7-methanoinden-5-yl acrylate | 1640-06-8 |
| 4,7-Methano-1H-inden-5-ol, 3a,4,5,6,7,7a-hexahydro-, | 2500-83-6 |
| acetate | |
| 1-(1-adamantyl)ethanone | 1660-04-4 |
| 1-(1-adamantyl)heptan-1-one | 32655-99-9 |
| 1-(1-adamantyl)hexadecan-1-one | 34130-74-0 |
| 1-[1-(2-ethylbutyl)cyclohexyl]propan-1-one | 4996-07-0 |
| 1-(3,5-dimethyl-1-adamantyl)ethanone | 40430-57-7 |
| tert-butylbicyclo[2.2.1]hept-5-ene-2-carboxylate | 154970-45-3 |
| tert-buty13-methylbicyclo[2.2.1]hept-5-ene-2-carboxylate | 1639268-86-2 |
| propan-2-ylbicyclo[2.2.1]hept-5-ene-2-carboxylate | 916824-62-9 |
| 2-methylbutan-2-ylbicyclo[2.2.1]hept-5-ene-2-carboxylate | 398140-58-4 |
| 2,2,4,4-tetramethylcyclobutane-1,3-dione | 933-52-8 |
| 2,2,4-trimethylcyclobutane-1,3-dione | 58548-57-5 |
| 2,2,4,4-tetramethylcyclobutan-1-one | 4298-75-3 |
| 2,2,4-trimethyl-3-oxopentanal | 1482-01-5 |
| 2,2,4-trimethylcyclobutan-1-one | 130647-61-9 |
| 2,2-dimethyl-3H-1-benzofuran-7-ol | 1563-38-8 |
| 7-methoxy-2,2-dimethyl-3H-1-benzofuran | 21763-49-5 |
| 7-ethoxy-2,2-dimethyl-3H-1-benzofuran | 53903-39-2 |
| 2,2-dimethyl-7-propan-2-yloxy-3H-1-benzofuran | 1346169-07-0 |
| 2-[(2,2-dimethyl-3H-1-benzofuran-7-yl)oxy]ethanol | 1153129-01-1 |
| 3,5,5-trimethylcyclohex-2-en-1-ol | 470-99-5 |
| 3-ethyl-5,5-dimethylcyclohex-2-en-1-ol | 31952-19-9 |
| 5,5-dimethyl-3-propylcyclohex-2-en-1-ol | 118465-28-4 |
| 5,5-dimethyl-3-(2-methylpropyl)cyclohex-2-en-1-ol | 2380508-74-5 |
| 3-butyl-5,5-dimethylcyclohex-2-en-1-ol | 133969-86-5 |
| 1-(2-hydroxyphenyl)propan-1-one | 610-99-1 |
| 1-(2-hydroxyphenyl)-2-methylpropan-1-one | 6640-69-3 |
| 3-(2-hydroxyphenyl)-3-oxopropanal | 14386-66-4 |
| 1-(2,6-dihydroxyphenyl)propan-1-one | 3361-72-6 |
| 3-amino-1-(2-hydroxyphenyl)propan-1-one | 1499545-17-3 |
| 5-methylnonan-2-one | 2358176-40-4 |
| 5-methyloctan-2-one | 58654-67-4 |
| 5-methyldecan-2-one | 56608-65-2 |
| 5,9-dimethyldecan-2-one | 33933-82-3 |
| 5,10-dimethylundecan-2-one | 55105-48-1 |
| 2-ethyl-1,3-benzoxazole | 6797-13-3 |
| 2-(1,3-benzoxazol-2-yl)ethanol | 121356-82-9 |
| 2-(2-bromoethyl)-1,3-benzoxazole | 1159545-31-9 |
| 2-(1,3-benzoxazol-2-yl)acetaldehyde | 1378822-12-8 |
| 2-propyl-1,3-benzoxazole | 2008-05-1 |
| methyl(1R)-2-oxocyclopentane-1-carboxylate | 265317-94-0 |
| methyl2-oxocyclopentane-1-carboxylate | 10472-24-9 |
| methyl2,5-dioxocyclopentane-1-carboxylate | 2825007-84-7 |
| ethyl2-oxocyclopentane-1-carboxylate | 611-10-9 |
| hexyl2-oxocyclopentane-1-carboxylate | 72845-82-0 |
| butyl2-oxocyclopentane-1-carboxylate | 6627-69-6 |
| methyl3-methylbenzoate | 99-36-5 |
| methyl3,5-dimethylbenzoate | 25081-39-4 |
| methyl3-(hydroxymethyl)benzoate | 67853-03-6 |
| methyl3-formylbenzoate | 52178-50-4 |
| methyl3-(methoxymethyl)benzoate | 1515-87-3 |
| 5-methoxy-2-methyl-1,3-benzothiazole | 2941-69-7 |
| 5-ethoxy-2-methyl-1,3-benzothiazole | 123771-99-3 |
| 2-methyl-5-propoxy-1,3-benzothiazole | 1799562-88-1 |
| 2-methyl-5-prop-2-ynoxy-1,3-benzothiazole | 64225-41-8 |
| 2-[(2-methyl-1,3-benzothiazol-5-yl)oxy]ethanol | 35465-77-1 |
| 2-methyl-1,3-benzothiazole | 120-75-2 |
| 2-methyl-5,6-didehydro-1,3-benzothiazole | 2995297-34-0 |
| 2-(iodomethyl)-1,3-benzothiazole | 229643-15-6 |
| 2-(fluoromethyl)-1,3-benzothiazole | 18020-07-0 |
| 8-tricyclo[5.2.1.02,6]dec-4-enylacetate | 2500-83-6 |
| 8-tricyclo[5.2.1.02,6]dec-4-enyl2-methylpropanoate | 67634-20-2 |
| 3-tricyclo[5.2.1.02,6]dec-8-enylacetate | 585570-07-6 |
| 8-tricyclo[5.2.1.02,6]dec-4-enylprop-2-enoate | 1640-06-8 |
| 3,3,5-trimethylcyclohexan-1-one | 873-94-9 |
| 3,3,5,5-tetramethylcyclohexan-1-one | 14376-79-5 |
| 5,5,7,7-tetramethyloctan-3-one | 1081518-68-4 |
| 2,2,6,6,8,8-hexamethylnonan-4-one | 20784-78-5 |
| 3,3-dimethylcyclohexan-1-one | 2979-19-3 |
| 2-ethyl-3-methylcyclohexan-1-one | 75731-83-8 |
| 3,4,4a,5,6,7,8,8a-octahydro-2H-naphthalen-1-one | 21370-71-8 |
| 2,3-diethylcyclohexan-1-one | 312926-20-8 |
| bicyclo[9.4.0]pentadecan-12-one | 62940-03-8 |
| 2-hexyl-3-methylcyclohexan-1-one | 13714-84-6 |
| 2-octan-3-ylcyclohexan-1-one | 74608-45-0 |
| 2-cyclohexylcyclohexan-1-one | 90-42-6 |
| 2-heptan-2-ylcyclohexan-1-one | 187852-36-4 |
| 2-cyclooctylcyclohexan-1-one | 14109-19-4 |
| 2-octan-2-ylcyclohexan-1-one | 54549-90-5 |

### Process of Making a Consumer Product

The present disclosure also relates to processes of making a consumer product. For example, the process may comprise the steps of: combining a first fragrance material with a treatment adjunct or a substrate, where the first fragrance material is an adamantyl ester-containing compound, preferably 2-adamantyl propanoate, more preferably 2-adamantyl acetate, and even more preferably 2-methyl-2-adamantyl acetate.

Preferably, the first fragrance material is in liquid form. The first fragrance material may be combined with one or more other materials. For example, the first fragrance material may be part of a fragrance composition that comprises at least a second fragrance material.

The first fragrance material may be part of a fragrance composition, which may be combined with a treatment adjunct to form a consumer product.

The consumer products of the present disclosure can be formulated into any suitable form and prepared by any process chosen by the formulator. The first fragrance materials, second fragrance materials (if any), fragrance compositions, treatment adjuncts, and/or base compositions may be combined in a batch process, in a circulation loop process, and/or by an in-line mixing process. Suitable equipment for use in the processes disclosed herein may include continuous stirred tank reactors, homogenizers, turbine agitators, recirculating pumps, paddle mixers, high shear mixers, static mixers, plough shear mixers, ribbon blenders, vertical axis granulators and drum mixers, both in batch and, where available, in continuous process configurations, spray dryers, and extruders.

The resulting compositions may be placed into a container to form a consumer product, as described herein. The container may be a bottle, preferably a plastic bottle, more preferably a plastic bottle comprising recycled plastic. The resulting composition may be placed into an aerosol or other spray container according to known methods.

The process may comprise the steps of combining a first fragrance material with a substrate. The substrate may be a non-woven sheet. The substrate may be an absorbent material or article. The first fragrance may be combined with the substrate by any suitable method, including spraying.

### Process of Treatment

The present disclosure also relates to a process of treating a surface or an environment with is an adamantyl ester-containing compound, preferably 2-Methyl-2-adamantyl acrylate, more preferably 2-adamantyl propanoate, more preferably 2-adamantyl acetate, and even more preferably 2-methyl-2-adamantyl acetate, as described in more detail above. The adamantyl ester-containing compound may be part of a consumer product.

The process of treatment comprises the step of providing the adamantyl ester-containing compound to a surface or environment. Suitable surfaces may include fabric, hard surfaces, dishware, hair, or skin. Suitable environments may include interior spaces such as a room in a residential dwelling, a commercial property, or an industrial setting.

The process may include the step of contacting a surface, preferably a fabric, with the adamantyl ester-containing compound, optionally as part of a consumer product according to the present disclosure.

The process may include the step of providing the adamantyl ester-containing compound to an environment, preferably an interior environment, optionally as part of a consumer product according to the present disclosure. The step of providing the adamantyl ester-containing compound may occur via a spraying process or through diffusion.

### Use

The present disclosure also relates to the use of an adamantyl ester-containing compound, preferably 2-adamantyl propanoate, more preferably 2-adamantyl acetate, and even more preferably 2-methyl-2-adamantyl acetate, to provide a pleasing fragrance to a consumer product, a surface, or an environment. Such materials, products, surfaces, and environments are discussed in more detail above.

### Combinations

Specifically contemplated combinations of the disclosure are herein described in the following lettered paragraphs. These combinations are intended to be illustrative in nature and are not intended to be limiting.

A. A consumer product comprising: a first fragrance material consisting of a compound G-C(O)—O-Q; wherein G and Q are carbon-containing radicals connected only through an ester bond; wherein Q comprises a single adamantyl moiety; wherein only one carbon atom of the adamantyl moiety is substituted with something other than —H; wherein the compound is selected from the group consisting of:

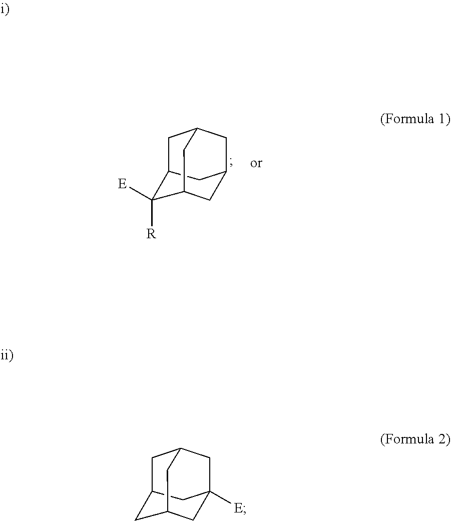

or
iii) mixtures thereof;
   wherein for either Formula 1 or formula 2:
      a. R is a hydrogen or a hydrocarbyl;
      b. E contains only a single —CO₂— moiety;
      c. the molecular formula is C₁₁₊ₙH₁₆₊₂ₙ₋ₘO₂,
         wherein n is an integer from 1 to 7, and m is 0 or 2; and
         wherein when m is 0, the molecule contains no carbon-carbon double bonds; and
         wherein when m is 2, the molecule contains a single carbon-carbon double bond; and
b) a treatment adjunct; and wherein the first fragrance material is present in an amount of at least 0.0005%, by weight of the consumer product composition.

B. The consumer product according to paragraph A, wherein n is an integer from 1 to 5.

C. The consumer product according to either paragraphs A or B, wherein n is an integer from 1 to 3.

D. The consumer product according to any of paragraphs A-C, wherein n is an integer from 1 to 2.

E. The consumer product according to any of paragraphs A-D, wherein m is 0.

F. The consumer product according to any of paragraphs A-E, wherein the first fragrance material is selected from a group consisting of:

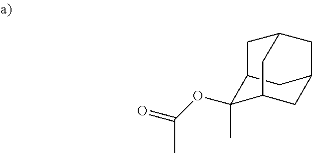

and

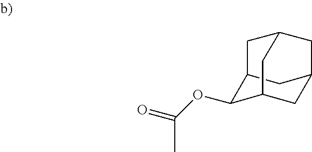

and

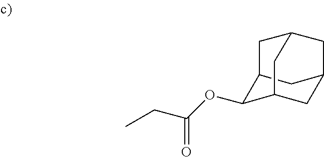

and

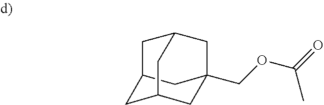

and

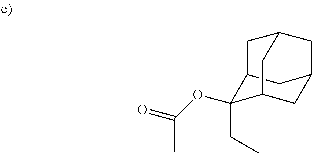 [SMILES: CCC1(OC(C)=O)C2CC3CC(C2)CC1C3]

and

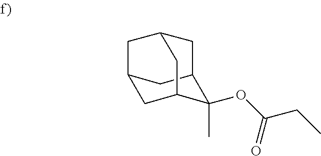 [SMILES: CCC(=O)OC1(C)C2CC3CC(C2)CC1C3]

and
g) mixtures thereof.

G. The consumer product of according to any of paragraphs A-F, further comprising a second fragrance material selected from a group consisting of:

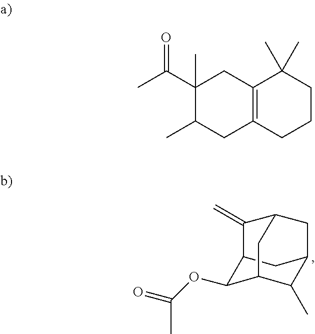 [SMILES: CC(=O)C1(C)CC2=C(CCCC2(C)C)CC1C ; C=C1C2CC3CC1C(OC(C)=O)C(C2)C3C]

and
c) mixtures thereof.

H. The consumer product according to any of paragraphs A-G, wherein the consumer product further comprises an antioxidant, and the first fragrance material is:

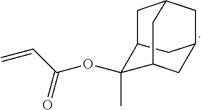 [SMILES: C=CC(=O)OC1(C)C2CC3CC(C2)CC1C3]

I. The consumer product according to any of paragraphs A-H, wherein the consumer product further comprises an antioxidant, and the first fragrance material is:

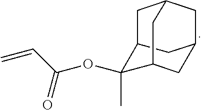 [SMILES: C=CC(=O)OC1(C)C2CC3CC(C2)CC1C3]

J. The consumer product according to any of paragraphs A-I, wherein the weight ratio of the first fragrance material to the second fragrance material is from 100:0 to 25:75, preferably from 100:0 to 50:50, more preferably from 100:0 to 51:49, more preferably from 100:0 to 75:25, more preferably from 100:0 to 90:10, more preferably from 100:0 to 95:5, more preferably from 100:0 to 99:1.

K. The consumer product according to any of paragraphs A-J, wherein the first fragrance material is present in the consumer product in an amount of at least 0.001%, preferably at least 0.01%, more preferably at least 0.1%, more preferably at least 0.5%, more preferably at least 1%, by weight of the consumer product.

L. The consumer product according to any of paragraphs A-K, wherein the first fragrance material is present in the consumer product in an amount of at least 0.001%, preferably at least 0.01%, more preferably at least 0.1%, more preferably at least 0.5%, more preferably at least 1%, by weight of the consumer product.

M. The consumer product according to any of paragraphs A-L, wherein the first fragrance material is part of a perfume delivery system, where the perfume delivery system is a delivery particle, a pro-fragrance material, or a combination thereof.

N. The consumer product according to any of paragraphs A-M, wherein the first fragrance material is part of a perfume delivery system, where the perfume delivery system is a delivery particle, a pro-fragrance material, or a combination thereof.

O. The consumer product according to any of paragraphs A-N, wherein the treatment adjunct is selected from a group consisting of: surfactants, conditioning actives, deposition aids, rheology modifiers, structurants, bleach systems, stabilizers, builders, chelating agents, dye transfer inhibiting agents, dispersants, enzymes, enzyme stabilizers, catalytic metal complexes, polymeric dispersing agents, clay and soil removal/anti-redeposition agents, brighteners, suds suppressors, silicones, hueing agents, aesthetic dyes, neat perfume, additional perfume delivery systems, structure elasticizing agents, carriers, hydrotropes, processing aids, anti-agglomeration agents, coatings, formaldehyde scavengers, pigments, or mixtures thereof.

P. The consumer product according to any of paragraphs A-O, wherein the treatment adjunct comprises a carrier, preferably a carrier comprising isopropyl myristate (IPM), Neobee® caprylic/capric triglyceride, dipropylene glycol, propylene glycol monomethyl ether (DPM), tripropyleneglycol monomethyl ester (TPM), triethyl citrate (TEC), or a mixture thereof, more preferably a carrier comprising isopropyl myristate.

Q. The consumer product according to any of paragraphs A-P, wherein the consumer product is a baby care product, a beauty care product, a fabric care product, a home care product, a family care product, a feminine care product, a health care product, a food product, a beverage product, a fine fragrance product, or a combination thereof.

R. The consumer product according to any of paragraphs A-Q, wherein the consumer product is a fabric care product and/or a home care product, wherein the home care product is selected from the group consisting of a hard surface cleaner, a dish care product, an air care product, or a combination thereof.

S. The consumer product according to any of paragraphs A-R, wherein the consumer product comprises a form selected from a liquid composition, a granular composition, a hydrocolloid, a single-compartment pouch, a multi-compartment pouch, a dissolvable sheet, a pastille or bead, a fibrous article, a tablet, a stick, a bar, a flake, a spray, a foam/mousse, a non-woven sheet, a cream, an absorbent article, a paste, a gel, an adhesive, an adhesive patch, or a mixture thereof.

T. A process of making a consumer product, the process comprising the steps of:
combining a first fragrance material with a treatment adjunct or a substrate, wherein the first fragrance material is a compound G-C(O)—O-Q; wherein G and Q are carbon-containing radicals connected only through an ester bond; wherein Q comprises a single adamantyl moiety; wherein only one carbon atom of the adamantyl moiety is substituted with something other than-H; wherein the compound is selected from the group consisting of:

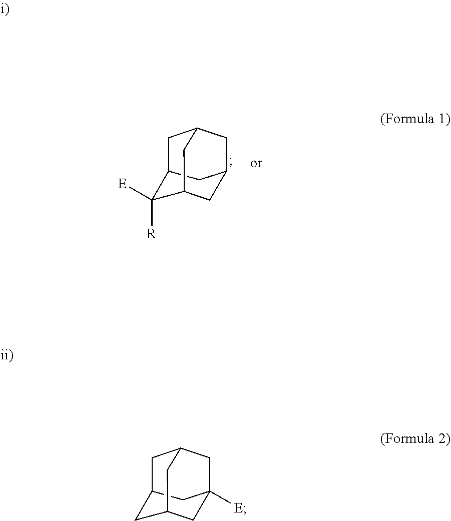

or
   iii) mixtures thereof;
      wherein for either Formula 1 or formula 2:
         A) R is a hydrogen or a hydrocarbyl;
         B) E contains only a single —CO₂— moiety;
         C) the molecular formula is C₁₁₊ₙH₁₆₊₂ₙ₋ₘO₂,
         wherein n is an integer from 1 to 7, and m is 0 or 2; and
         wherein when m is 0, the molecule contains no carbon-carbon double bonds; and
         wherein when m is 2, the molecule contains a single carbon-carbon double bond.

U. The process according to paragraph T, wherein the first fragrance material is in liquid form.

V. A process of treating a surface or an environment, the process comprising the step of providing a compound G-C(O)—O-Q, wherein G and Q are carbon-containing radicals connected only through an ester bond; wherein Q comprises a single adamantyl moiety; wherein only one carbon atom of the adamantyl moiety is substituted with something other than-H; wherein the compound is selected from the group consisting of:

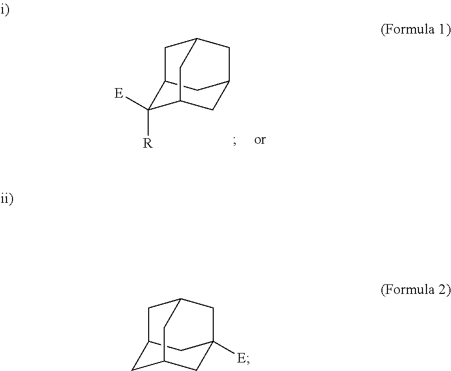

or
iii) mixtures thereof;
   wherein for either Formula 1 or formula 2:
      A) R is a hydrogen or a hydrocarbyl;
      B) E contains only a single —CO₂— moiety;
      C) the molecular formula is C₁₁₊ₙH₁₆₊₂ₙ₋ₘO₂,
         wherein n is an integer from 1 to 7, and m is 0 or 2; and
         wherein when m is 0, the molecule contains no carbon-carbon double bonds; and
         wherein when m is 2, the molecule contains a single carbon-carbon double bond;
to a surface or environment.

W. A use of a compound G-C(O)—O-Q, wherein G and Q are carbon-containing radicals connected only through an ester bond; wherein Q comprises a single adamantyl moiety; wherein only one carbon atom of the adamantyl moiety is substituted with something other than-H; wherein the compound is selected from the group consisting of:

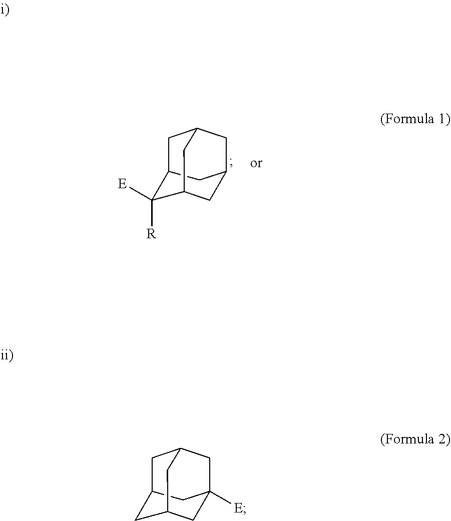

or
iii) mixtures thereof;
   wherein for either Formula 1 or formula 2:
      A) R is a hydrogen or a hydrocarbyl;
      B) E contains only a single —CO₂— moiety;
      C) the molecular formula is C₁₁₊ₙH₁₆₊₂ₙ₋ₘO₂,
         wherein n is an integer from 1 to 7, and m is 0 or 2; and
         wherein when m is 0, the molecule contains no carbon-carbon double bonds; and
wherein when m is 2, the molecule contains a single carbon-carbon double bond, to provide a fragrance to a consumer product, a surface, or an environment.

### Test Methods

It is understood that the test methods disclosed in the Test Methods section of the present application should be used to determine the respective values of the parameters of Applicant's claimed subject matter as claimed and described herein.

### Headspace Method

Perfume headspace data is collected for various materials according to the method provided below.

The partition coefficients are calculated by determining the amount of PRM in the headspace above a solution with a known concentration using a GC/FID-MS (Agilent 7890 and 5977A MSD) with a thermal desorption unit (Gerstel MPS2) and Dynamic Headspace Sampler (Gerstel DHS). This technique allows for automated headspace collections using the MultiPurposeSampler (MPS). The PRMs of interest are prepared at a known concentration in isopropyl myristate (IPM) or propylene glycol monomethyl ether (DPM), and 1 mL is pipetted in a 20 mL headspace vial.

DHS Conditions: The sample is tempered in the unit at 30° C. A helium stream at 10 mls/min purges 20 mL of headspace containing the analytes above the sample onto the sorbent tube (TDU) containing 25 mg of TenaxTA 35/60 (Restek cat #25701).

TDU conditions: The sorbent tube is desorbed with a program starting at 30° C. solvent vent for 2 min then ramped at 720° C./min to 270° C. and held for 8 min. The analytes are refocused on a glass bead liner at −60° C. then desorbed at a rate of 12° C./s to 270° C. onto the GC column.

GC/MS conditions: Agilent 122-5532 UI column of 30 m×250 μm×0.25 μm and a flow rate of 1.5 mL/min is utilized. A temperature program of 50° C. to 280° C. with a 2 min hold and a ramp rate of 12° C./min is suitable. Scan or SIM mode MSD parameters with a solvent delay for the DPM are applied to achieve appropriate detection.

Analytical standards can be obtained from AK Scientific, Inc., Union City, CA 94587, USA. A stock solution is prepared at approximately 0.5 g/L. The stock solution is then diluted to 4 to 5 concentrations ranging from approximately 0.05 g/L to 0.00005 g/L. These standard solutions are then analyzed by GC/MS. This analysis is performed by using the same TDU desorption and GC/MS conditions described above with a 1 μL liquid injection onto the TDU tube instead of the DHS collection. The amount injected on column and the area responses of the target m/z are utilized to create a calibration plot with a linear fit.

Quantification of the headspace is performed by the PRM target m/z area response of the perfume component and the linear equation of the calibration plot.

### Examples

The examples provided below are intended to be illustrative in nature and are not intended to be limiting.

### Example 1. Headspace Data

Perfume headspace data is collected for various materials according to the Headspace Method provided above in the Test Methods section. The Air/Solvent partition coefficients are determined and indexed accordingly (e.g., where the partition coefficient for OTNE is set at 1.00).

Results for 2-adamantyl propanoate, 2-adamantyl acetate, and 2-methyl-2-adamantyl acetate in isopropyl myristate (IPM) are provided below in Table 1.

TABLE 1

| | | | | | OTNE |
|---|---|---|---|---|---|
| | | | | Air/IPM | Indexed |
| | | | | partition coef | Air/IPM |
| | | Concentration in | Head-space | (ng/mL in air per | partition |
| Sample | CAS No. | IPM (ng/mL) | (ng/mL)* | ng/mL in IPM)* | coefficient* |
| OTNE | 54464-57-2 | 2.04E+06 | 0.0216 | 1.04E−08 | 1.00 |
| (comp.) | | | | | |
| 2-adamantyl | 19066-22-9 | 2.07E+06 | 0.1793 | 8.66E−08 | 8.30 |
| acetate | | | | | |
| 2-methyl-2- | 58081-36-0 | 2.05E+06 | 0.1874 | 9.05E−08 | 8.67 |
| adamantyl | | | | | |
| acetate | | | | | |
| 2-adamantyl | 2662511-98-8 | 2.09E+06 | 0.1182 | 5.71E−08 | 5.47 |
| propanoate | | | | | |

*Average of three replicates.

Overall, the tested adamantyl ester-containing compounds are found in the headspace between about 5.5× and 8.7× more than OTNE out of IPM, a common solvent used in perfume delivery particles. The increase in volatility of adamantyl ester containing compounds compared to OTNE is advantageous because a higher fraction of adamantyl ester-containing compounds will be found in the air from the consumer product. Therefore, adamantyl ester-containing compounds will be more likely to be perceived at lower levels in consumer products or at greater intensity at equal levels in consumer products.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A consumer product comprising:
a) a first fragrance material consisting of a compound G-C(O)—O-Q;
wherein G and Q are carbon-containing radicals connected only through an ester bond;
wherein Q comprises a single adamantyl moiety;
wherein only one carbon atom of the adamantyl moiety is substituted with something other than-H;
wherein the compound is selected from the group consisting of: 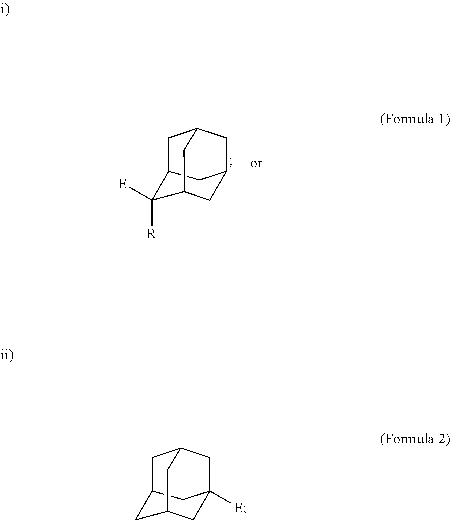
or
iii) mixtures thereof;
wherein for either Formula 1 or formula 2:
a. R is a hydrogen or a hydrocarbyl;
b. E contains only a single —CO₂— moiety;
c. the molecular formula is C₁₁₊ₙH₁₆₊₂ₙ₋ₘO₂,
wherein n is an integer from 1 to 7, and m is 0 or 2; and
wherein when m is 0, the molecule contains no carbon-carbon double bonds; and
wherein when m is 2, the molecule contains a single carbon-carbon double bond; and
b) a treatment adjunct; and
wherein the first fragrance material is present in an amount of at least 0.0005%, by weight of the consumer product composition.

2. The consumer product according to claim 1, wherein n is an integer from 1 to 5.

3. The consumer product according to claim 1, wherein n is an integer from 1 to 3.

4. The consumer product according to claim 1, wherein n is an integer from 1 to 2.

5. The consumer product according to claim 1, wherein m is 0.

6. The consumer product of claim 1, wherein the first fragrance material is selected from a group consisting of: 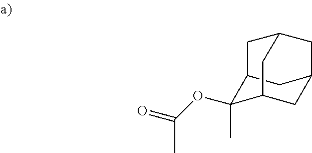
and 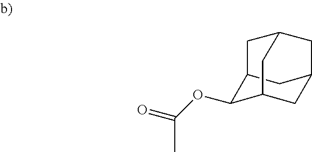
and 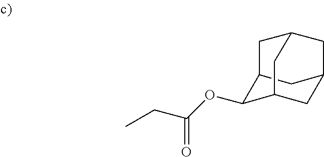
and 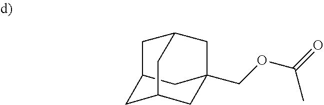
and 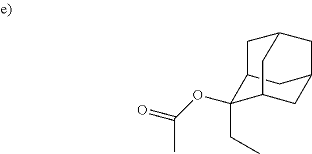 [SMILES: CCC1(OC(C)=O)C2CC3CC(C2)CC1C3]
and 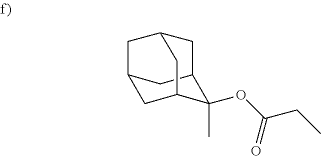 [SMILES: CCC(=O)OC1(C)C2CC3CC(C2)CC1C3]
and
g) mixtures thereof.

7. The consumer product of claim 1, further comprising a second fragrance material selected from a group consisting of: 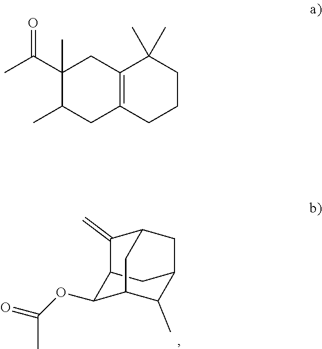 [SMILES: CC(=O)C1(C)CC2=C(CCCC2(C)C)CC1C ; C=C1C2CC3CC1C(OC(C)=O)C(C2)C3C]
and
c) mixtures thereof.

8. The consumer product of claim 1, wherein the consumer product further comprises an antioxidant, and the first fragrance material is:

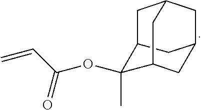 [SMILES: C=CC(=O)OC1(C)C2CC3CC(C2)CC1C3]

9. The consumer product of claim 7, wherein the consumer product further comprises an antioxidant, and the first fragrance material is:

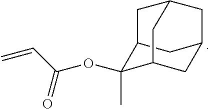 [SMILES: C=CC(=O)OC1(C)C2CC3CC(C2)CC1C3]

10. The consumer product according to claim 7, wherein the weight ratio of the first fragrance material to the second fragrance material is from 100:0 to 25:75, preferably from 100:0 to 50:50, more preferably from 100:0 to 51:49, more preferably from 100:0 to 75:25, more preferably from 100:0 to 90:10, more preferably from 100:0 to 95:5, more preferably from 100:0 to 99:1.

11. The consumer product according to claim 1, wherein the first fragrance material is present in the consumer product in an amount of at least 0.001%, preferably at least 0.01%, more preferably at least 0.1%, more preferably at least 0.5%, more preferably at least 1%, by weight of the consumer product.

12. The consumer product according to claim 7, wherein the first fragrance material is present in the consumer product in an amount of at least 0.001%, preferably at least 0.01%, more preferably at least 0.1%, more preferably at least 0.5%, more preferably at least 1%, by weight of the consumer product.

13. The consumer product according to claim 1, wherein the first fragrance material is part of a perfume delivery system, where the perfume delivery system is a delivery particle, a pro-fragrance material, or a combination thereof.

14. The consumer product according to claim 7, wherein the first fragrance material is part of a perfume delivery system, where the perfume delivery system is a delivery particle, a pro-fragrance material, or a combination thereof.

15. The consumer product according to claim 1, wherein the treatment adjunct is selected from a group consisting of: surfactants, conditioning actives, deposition aids, rheology modifiers, structurants, bleach systems, stabilizers, builders, chelating agents, dye transfer inhibiting agents, dispersants, enzymes, enzyme stabilizers, catalytic metal complexes, polymeric dispersing agents, clay and soil removal/anti-redeposition agents, brighteners, suds suppressors, silicones, hueing agents, aesthetic dyes, neat perfume, additional perfume delivery systems, structure elasticizing agents, carriers, hydrotropes, processing aids, anti-agglomeration agents, coatings, formaldehyde scavengers, pigments, or mixtures thereof.

16. The consumer product according to claim 1, wherein the treatment adjunct comprises a carrier, preferably a carrier comprising isopropyl myristate (IPM), Neobee® caprylic/capric triglyceride, dipropylene glycol, propylene glycol monomethyl ether (DPM), tripropyleneglycol monomethyl ester (TPM), triethyl citrate (TEC), or a mixture thereof, more preferably a carrier comprising isopropyl myristate.

17. The consumer product according to claim 1, wherein the consumer product is a baby care product, a beauty care product, a fabric care product, a home care product, a family care product, a feminine care product, a health care product, a food product, a beverage product, a fine fragrance product, or a combination thereof.

18. The consumer product according to claim 1, wherein the consumer product is a fabric care product and/or a home care product, wherein the home care product is selected from the group consisting of a hard surface cleaner, a dish care product, an air care product, or a combination thereof.

19. The consumer product according to claim 1, wherein the consumer product comprises a form selected from a liquid composition, a granular composition, a hydrocolloid, a single-compartment pouch, a multi-compartment pouch, a dissolvable sheet, a pastille or bead, a fibrous article, a tablet, a stick, a bar, a flake, a spray, a foam/mousse, a non-woven sheet, a cream, an absorbent article, a paste, a gel, an adhesive, an adhesive patch, or a mixture thereof.

20. A process of making a consumer product, the process comprising the steps of:
combining a first fragrance material with a treatment adjunct or a substrate,
wherein the first fragrance material is a compound G-C(O)—O-Q;
wherein G and Q are carbon-containing radicals connected only through an ester bond;
wherein Q comprises a single adamantyl moiety;
wherein only one carbon atom of the adamantyl moiety is substituted with something other than-H;
wherein the compound is selected from the group consisting of: 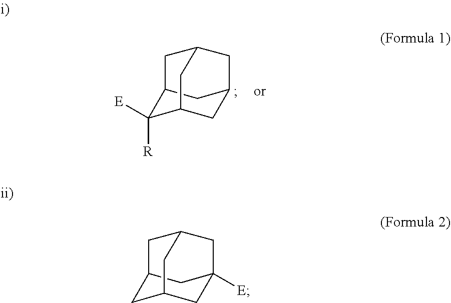
or
iii) mixtures thereof;
wherein for either Formula 1 or formula 2:
A) R is a hydrogen or a hydrocarbyl;
B) E contains only a single —CO₂— moiety;
C) the molecular formula is C₁₁₊ₙH₁₆₊₂ₙ₋ₘO₂,
wherein n is an integer from 1 to 7, and m is 0 or 2; and
wherein when m is 0, the molecule contains no carbon-carbon double bonds; and
wherein when m is 2, the molecule contains a single carbon-carbon double bond.
